(19) United States
(12) Patent Application Publication
(10) Pub. No.: US 2016/0173202 A1
(43) Pub. Date: Jun. 16, 2016

(54) Adaptive Noise Loading in Optical Communication Networks

(71) Applicant: Alcatel-Lucent Canada Inc., Ottawa (CA)

(72) Inventor: Colin G. Kelly, Ottawa (CA)

(73) Assignee: Alcatel-Lucent Canada Inc., Ottawa (CA)

(21) Appl. No.: 14/955,268

(22) Filed: Dec. 1, 2015

Related U.S. Application Data
(60) Provisional application No. 62/092,400, filed on Dec. 16, 2014.

(51) Int. Cl. H04B 10/564; H04J 14/02; H04B 10/079

(52) U.S. Cl. CPC H04B 10/564; H04B 10/07955; H04J 14/0221

(57) ABSTRACT

An apparatus is provided, e.g. an optical transmitter, that includes an optical noise source and an optical coupler. The optical noise source is configured to produce light having a noise spectrum and is optically coupled to a selected one of the inputs. The optical noise conditioner is configured to receive the light from the optical noise source and to form a noise slice of the noise spectrum. The optical noise conditioner includes a wavelength blocker located in an optical path between the optical noise source and the optical coupler; and, an optical amplifier located in an optical path between the wavelength blocker and the optical coupler.

### CROSS-REFERENCE TO RELATED APPLICATIONS

This Application claims the benefit of provisional Applications No. 62/092,400, filed on Dec. 16, 2014, and 62/111,530, filed on Feb. 3, 2015, both by Colin Kelly and incorporated by reference herein in their entireties.

### TECHNICAL FIELD

The present invention relates generally to the field of optical communications, and, more particularly, but not exclusively, to methods and apparatus for equalizing optical power loading on a fiber optical cable.

### BACKGROUND

This section introduces aspects that may be helpful to facilitate a better understanding of the inventions. Accordingly, the statements of this section are to be read in this light and are not to be understood as admissions about what is in the prior art or what is not in the prior art. Any techniques or schemes described herein as existing or possible are presented as background for the present invention, but no admission is made thereby that these techniques and schemes were heretofore commercialized, or known to others besides the inventors.

Some optical communications systems, particularly submerged systems, add optical noise to an optical data signal to maintain about a constant optical power loading. Such constant power generally provides more uniform propagation characteristics of the optical transport medium, e.g. an optical fiber. Under certain conditions, e.g. short-term or long-term changes of the data signal spectral power distribution, it may be difficult to maintain about constant optical power in a manner that effectively provides the desired uniform propagation characteristics.

### SUMMARY

The inventors disclose various apparatus and methods that may be beneficially applied to, e.g., optical communication systems, e.g. submarine communications networks. While such embodiments may be expected to provide improvements in performance and/or security of such apparatus and methods, no particular result is a requirement of the present invention unless explicitly recited in a particular claim.

One embodiment provides an apparatus, e.g. an optical transmitter, including an optical noise source and an optical coupler having a plurality of inputs and an output. The noise source is configured to produce light having a noise spectrum, and is optically coupled to a selected one of the inputs of the coupler. An optical noise conditioner includes a wavelength blocker located in an optical path between the optical noise source and the optical coupler. The optical noise conditioner further includes an optical amplifier located in an optical path between the wavelength blocker and the optical coupler. The optical noise conditioner is configured to receive the light from the optical noise source and to form a noise slice of the noise spectrum.

In some embodiments the wavelength blocker includes a wavelength-selective switch (WSS), and in some embodiments the wavelength blocker includes digital mirror device (DMD). In some embodiments the optical noise source includes a superluminescent laser diode, followed by a depolarizer such as a Lyot filter. In other embodiments, this noise source may produce self-generated amplified spontaneous emission (ASE) noise from an optical amplifier (such as an EDFA), without any optical input. In some embodiments a power control loop is configured to modulate the power of the noise slice in response to a total optical power output by the optical coupler.

In some embodiments a tap is configured to direct a data signal towards another of the plurality of optical coupler inputs, and to direct a monitor signal towards a noise controller configured to adjust a power level of the noise slice in response to a power level of the monitor signal. In some embodiments the data signal includes an aggregate WDM signal that includes channels that originate from a plurality of sources. In some such embodiments the noise controller is further configured to adjust the power level of the noise slice in response to a power level of an output signal provided by an output of the optical coupler. In some other embodiments an optical delay path is configured to delay the data signal between the tap and the optical coupler.

Some embodiments include an amplifier located in an optical path from the wavelength blocker to the optical coupler. Some embodiments include an amplifier located in an optical path between the optical noise source and the wavelength blocker. Some embodiments include an optical attenuator located in an optical path between the wavelength blocker and the optical coupler. Some embodiments include an optical attenuator and an optical amplifier located in an optical path between the wavelength blocker to the optical coupler.

In some embodiments the wavelength blocker is a first wavelength blocker, and the apparatus further comprises a second wavelength blocker located in an optical path between said optical amplifier and said optical coupler. Some embodiments further include an optical attenuator located in an optical path between said optical amplifier and said optical coupler.

Another embodiment provides an apparatus, e.g. an optical transmitter, that includes an optical delay line and an optical coupler. The optical delay line is configured to receive at an input an aggregate data signal formed by a combination of a plurality of wavelength division multiplexed optical signals. The optical coupler is configured to receive at a first input the aggregate data signal from the optical delay line. An optical noise source is configured to direct to a second input of the optical coupler noise light including a plurality of noise slices. A power monitor is configured to receive signal light from a tap located in an optical path before the delay line input and to direct an electrical measure of the signal light to a noise controller configured to modulate a power of the noise light in response to the electrical measure.

Some embodiments of the apparatus further include an optical channel monitor configured to provide spectral information of the signal light to the noise controller, with the noise controller being further configured to modulate a spectrum of the noise light in response to the spectral information. In some further embodiments, the optical channel monitor is a first optical channel monitor, and the apparatus further includes a second optical channel monitor. The second channel monitor is configured to provide spectral information of light output by the coupler. The noise controller is further configured to modulate the spectrum of the noise light in response to the spectral information provided by the second optical channel monitor.

Other embodiments include methods, e.g. methods of manufacturing, of forming the various apparatus recited above, and methods of operating the various apparatus recited above.

### BRIEF DESCRIPTION OF THE DRAWINGS

A more complete understanding of the present invention may be obtained by reference to the following detailed description when taken in conjunction with the accompanying drawings wherein:

FIG. 1A illustrates an apparatus, e.g. an optical transmitter, configured according to some embodiments to add conditioned noise to a data-carrying optical signal using an optical noise conditioner that includes a wavelength blocker; FIG. 1B illustrates an embodiment of a portion of the optical transmitter of FIG. 1A in which the wavelength blocker is implemented using a wavelength-selective switch (WSS);

FIGS. 2A and 2B illustrate two example embodiments in which an optical noise source is implemented as a super-luminescent diode (SLD) (FIG. 2A) or an erbium-doped fiber amplifier (EDFA) (FIG. 2B);

FIGS. 3A-3D illustrate example embodiments of the optical noise conditioner of FIG. 1A;

FIG. 4 illustrates an embodiment, e.g. an optical transmitter, that employs the optical noise conditioner of FIG. 3D, and further monitors a spectrum of an aggregate input data signal before adding optical noise to the aggregate signal;

FIG. 5 illustrates an embodiment, e.g. an optical transceiver, that includes a delay line located between a first combiner that aggregates the input data signals and a second combiner that adds a noise signal to the aggregate data signal, and further includes a noise controller configured to provide feed-forward modulation of noise power to reduce transient response time as compared to the embodiment of FIG. 1.

### DETAILED DESCRIPTION

Various embodiments are now described with reference to the drawings, wherein like reference numbers are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

Submarine optical transmission systems typically employ initial loading, or pre-loading, of an optical path, e.g. a fiber-optic cable, to provide a consistent power load on the path. In some conventional submarine systems, dedicated loading lines are used, at fixed spectral locations, and the power of these loading lines is adjusted to maintain a constant total power as the number of data channels varies. In such systems, the source of the optical signals for data transmission may also be considered part of submarine vendor's equipment, with these optical signals terminated at the terminal ends of the submarine equipment (the terrestrial terminal sites). However, such solutions typically require a minimum number of fixed loading lines, which results in a loss in spectral efficiency, and also typically require additional optical regeneration of the optical data signals destined for transmission across the submarine network. Such transmission overhead adds additional cost and increased power consumption to the optical system. For shorter submarine links, an alternate solution is to receive transmission signals, such as dense wavelength-division multiplexed (DWDM) signals, from one or more terrestrial DWDM sources for transmission across the submarine link without any optical/electrical/optical regeneration at the submarine link terrestrial termination sites. In some existing terrestrial DWDM systems, the power per optical channel is constrained, but the number of channels may vary. Moreover, in accepting WDM signals from multiple sources, the number and location of the DWDM signals from these sources may vary and be uncontrollable. In such systems, there is a need to control the DWDM wavelengths accepted from the multiple sources, and to additionally add additional spectral power on loading lines (optical channels) as required to generate a constant-power aggregate signal suitable for transmission across the submarine system. There is also a need for such loading lines to be flexible in their power levels and spectral locations. Additionally, there is a need for less costly wideband optical noise generation that the multiple tunable lasers used as the optical source for the loading lines in come conventional implementations.

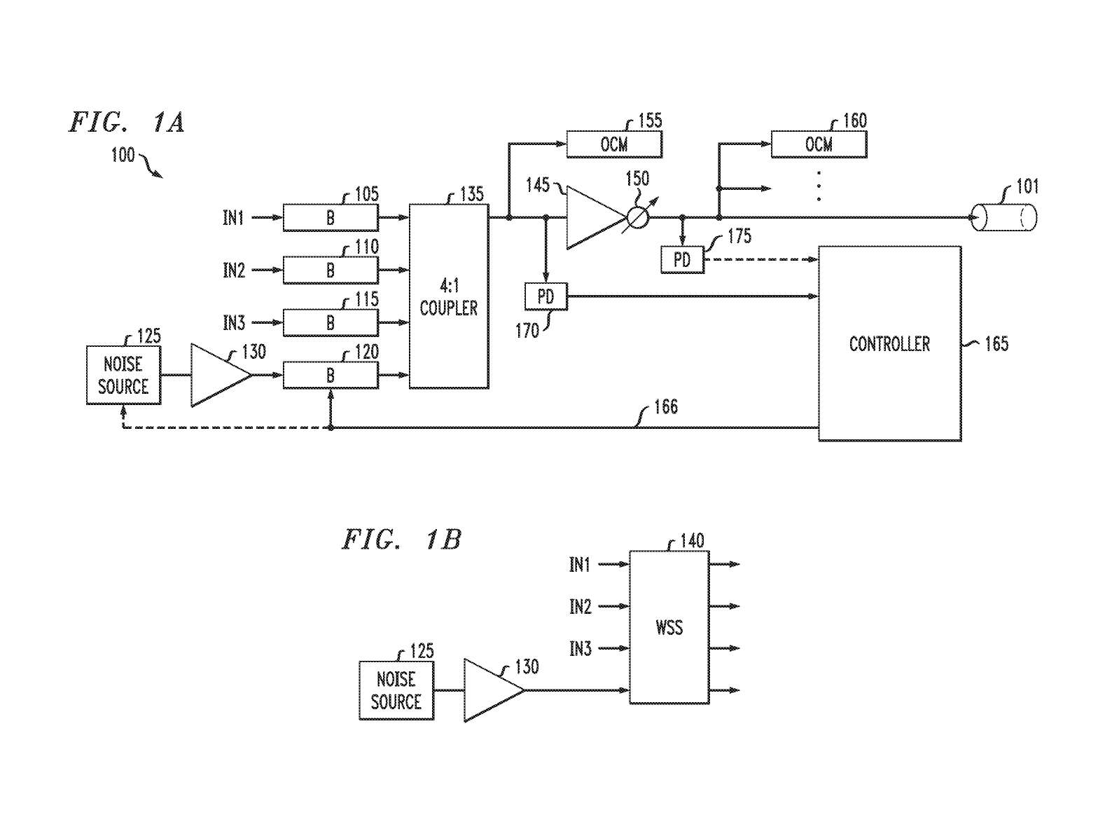

FIG. 1A illustrates an apparatus, e.g. an optical transmitter 100, configured according to various embodiments. The transmitter 100 may be a portion of an optical transceiver device, and is shown without a receiver portion without loss of generality. The transmitter 100 may be, and is shown in this embodiment as being, configured to provide an optical signal to a submarine optical communication system cable 101. Thus, the transmitter 100 accepts optical signals from a terrestrial side, and provides signals to a submarine land terminal (SLT) side. Three signal inputs are shown without limitation, IN1, IN2 and IN3. These inputs may each include one or more optical signals, which may be fixed- or flexible-grid aligned signals, from external optical transmission equipment. For example, one or more inputs may conform to the ITU-T 50 GHz DWDM grid. The inputs may each include content controlled by the owner of the transmitter 100 and/or controlled by an entity leasing the channel.

These channels are initially received by a corresponding one of wavelength blockers 105, 110 and 115. These blockers may be configured to select only portions of the optical spectrum from each input port, such that the selected channels from each input do not overlap even if the different inputs contain signals at the same wavelength. A fourth blocker 120 receives broadband noise signal from a noise source 125, which may also include an optical amplifier 130 to boost the noise power to a desired level.

As used herein, the term “wavelength blocker” (sometimes referred to herein simply as a “blocker”) is or includes a device that can block or pass selected portions of an optical spectrum, sometimes with adjustable attenuation. Some wavelength blockers employ a wavelength-selective switch (WSS)—such a blocker may be referred to herein as a WSS-type wavelength blocker, or WSS-type blocker. Some other wavelength blockers employ a digital mirror device (DMD), sometimes also referred to as a DLP (digital light processor)—such a blocker may be referred to herein as a DMD-type wavelength blocker, or DMD-type blocker. Some wavelength blockers, such as those described in some embodiments herein, are able to block selected wavelengths with finer spectral granularity than a channel spacing of a DWDM-modulated signal traversing the blocker.

In the embodiment of FIG. 1A, the blockers 105, 110, 115 and 120 are DMD-type blockers, the outputs of which are combined by an optical combiner, or coupler, 135. In some alternate embodiments, as illustrated in FIG. 1B, the four DMD-type blockers 105, 110, 115, and 120, and the coupler 135, may be replaced by a WSS-type blocker 140 having at least four inputs.

Returning to FIG. 1A, an amplifier 145 is configured to receive and amplify an output of the coupler 135. An optional attenuator 150, e.g. an electronic variable optical attenuator (eVOA), is configured to receive and attenuate the output of the amplifier 145. A first optical channel monitor (OCM) 155 may monitor the output of the coupler 135, and a second OCM 160 may monitor the output of the attenuator 150. Each OCM 155, 160 may be implemented in any conventional or novel manner, e.g. using spare blockers in a DMD blocker array, or a highly parallel implementation such a 640 pixel photodiode (PD) array. An unreferenced tap splits out one or more portions of the signal output by the attenuator 150 to provide additional functionality, including the connection to the OCM 160. A controller 165, e.g. a noise controller, may receive the outputs of the OCM 155 and/or 160 to monitor the combined spectrum (input sources plus noise loading) of the signal output by the coupler 135, pre- or post-amplification. The controller 165 may be implemented using any conventional or novel configuration of a processor and instruction memory, such as a digital signal processor (DSP), state machine or micro-controller.

The controller 165 may be configured to determine any spectral gaps in the incoming signals from inputs IN1, IN2, and IN3, and to determine a possible loss of channels from any of these inputs. In response to signals provided by the OCM 155 and/or the OCM 160 the controller 165 provides to the noise source 125 a feedback signal 166, e.g. a power control signal, and/or an attenuation control signal, to the blocker 120. In the event of a loss of an input channel, the OCM 155 and/or the OCM 160 may output an electrical signal indicative of the missing channel(s). The controller 165 may optionally reconfigure the blocker 120 (e.g. DMD- or WSS-based) to add noise from the noise source 125 where these spectral gaps are located. Alternatively or additionally, the controller 165 may reconfigure the noise source 125 to increase noise output such that the noise level increases at the spectral gaps.

The feedback controller 165 may operate to provide about a constant power, e.g. may be configured to provide the feedback signal 166 to the noise source 125 and/or the amplifier 130 to maintain constant power of the signal output by the coupler 135 and/or the attenuator 150. A first power monitor 170, e.g. a photodiode, produces an output indicative of a total power of the signal into the amplifier 145, while a second power monitor 175, e.g. photodiode, produces another signal indicative of the total power of the signal output by the attenuator 150. Embodiments may optionally include one or both of the power monitors 170, 175. The combination of one or more power monitors, e.g. the power monitors 170, 175, a noise controller, e.g. the controller 165, and a feedback path, e.g. the feedback path 166, configured to control the power and/or spectrum of the optical noise may be referred to herein as a power control loop. In response to one or both of the power monitors 170, 175, the controller 165 may operate to maintain about a constant optical power at the output of the coupler 135. In various embodiments the attenuator 150 is a “fast” eVOA. In such embodiments it may be preferable that the controller 165 be a fast controller. In this context, “fast” refers to the speed at which the power control loop responds to a power adjustment command, wherein the speed is comparable to or faster than the expected slew rates in the incoming optical power levels in the event of a sudden loss of one or more channels, thus causing an optical transient. Such transients may have step response times in the order of microseconds to milliseconds. In other embodiments the controller 165 and attenuator may be “slow”. This aspect is discussed in greater detail below. In some embodiments the controller 165 may contain a fast total power control loop. A total power control loop bases the feedback control on the total power of the combined optical signal, as distinguished from the power of a number of monitored channels.

In embodiments for which the blockers 105-120 and coupler 135 are implemented with a WSS, such WSS, especially if it is flex-grid capable, may preferably be an LCOS-based WSS. Such devices typically have a very slow response time to optical reconfiguration commands, possibly several seconds. In such embodiments, if a faster power control loop response time is desired it may be preferable to adjust the power level of the noise source 125 directly. Alternatively, in a blocker array implementation, each of the wavelength blockers 105-120 illustrated in FIG. 1A and in following embodiments may be implemented with a digital light processor (DLP)-based blocker array. An example of the latter embodiment is the Fourier Series Wave Blocker Array (WBA) manufactured by Nistica, Bridgewater, N.J., USA. In this embodiment, the intrinsic speed of the blockers to reconfiguration commands may be fast enough to permit power control by per-channel attenuation changes.

It is noted that feedback to the controller 165 that includes the power monitor 175 also includes the response time of the amplifier 145. Depending on the transient response requirements, it may be preferable to base the feedback response on the output of the power monitor 170. In such embodiments, the power monitor 170 may permit a fast response to be initiated before the transient has propagated through the amplifier 145. The power monitor 170 can be used by itself as an alternate tap point for a power feedback loop in conjunction with controller 165, or as a feed-forward signal to help minimize the power transient at the output of the attenuator 150. In the latter case, the feedback loop based on the power monitor 175 may be used for slightly slower, but more accurate, feedback loop adjustments.

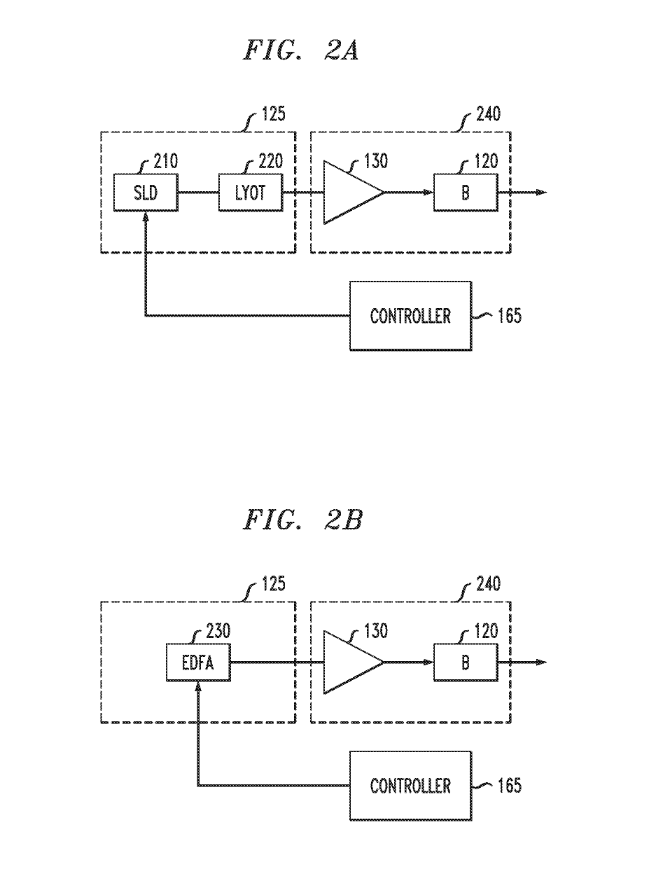

FIGS. 2A and 2B illustrate two alternate embodiments of the noise source 125. In FIG. 2A, a wideband light source 210 provides an optical signal with a bandwidth that includes at least the spectrum of the channels arriving from inputs IN1, IN2, and IN3. The light source 210 is not limited to any particular device, but is preferably a high intensity broadband optical emitter. In some cases, however, the intensity of the light source 210 may not be sufficient, and thus an optional post-emitter amplifier may be used. One suitable broadband emitter is the DL-CS5169A superluminescent LED (SLD), available from Denselight Semiconductors PTE, LTD, Singapore, which has a 3 dB bandwidth>75 nm centered at about 1537 nm, e.g. the optical C-band. A Lyot filter 220, which may be any suitable type, may be used to depolarize the output of the light source 210. If used, the Lyot filter 220 is treated herein as being a component of the noise source 125. FIG. 2B illustrates an embodiment in which the noise source 125 employs an optical amplifier 230, e.g. an EDFA. In such embodiments the EDFA may be operated at high gain without any optical input, thus generating broadband ASE noise.

In both cases, the power level of the light source 210, or a pump power level within the amplifier 230, may be adjusted by the controller 165 to control the overall noise power. Alternatively, the gain of the amplifier 275 may be adjusted instead. It is noted that control of the light source 210 power and/or the amplifier 230 power may lead to spectral changes in the shape of the broadband noise, which changes may be undesirable in some cases. In both embodiments, the blocker 120 selects spectral slices of the noise for insertion into the aggregated DWDM spectrum as required. A spectral slice, referred to herein and in the claims as a “noise slice”, is a portion of the optical spectrum of the noise source 125 bounded by a selected upper wavelength and a selected lower wavelength. The upper and lower wavelengths may be determined by, e.g. those wavelengths at which the power of the noise slice signal drops by at least about 3 dB relative to a peak power of the noise slice. The components located in the optical path between the noise source 125 and the coupler 135 (or alternatively the WSS 140) e.g. the amplifier 130, the wavelength blocker 120 are logically grouped into an optical noise conditioner 240, described further below.

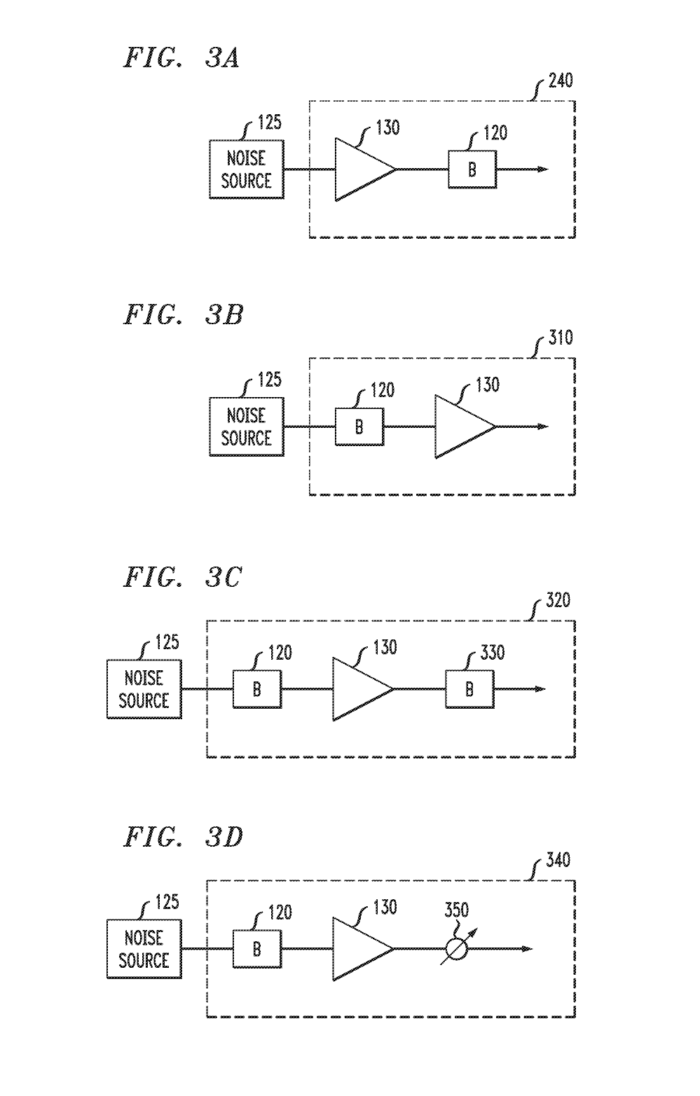

FIGS. 3A-3D illustrate alternate embodiments of the optical noise conditioner. FIG. 3A illustrates the noise controller 210 already presented in FIG. 1, e.g. the amplifier 130 followed by the wavelength blocker 120. In this embodiment the amplifier 130 preferably has sufficient power to amplify a broadband spectrum to offset losses due to the blocker 120. FIG. 3B illustrates a noise conditioner 310 that reverses the order of the wavelength blocker 120 and the amplifier 130. In this embodiment, the amplifier 130 only needs to amplify selected portions of the broadband noise spectrum received from the noise source 125. Furthermore, the amplifier 130 need not offset the loss of the blocker 120. As a result, this embodiment may eliminate the need for a high-power amplifier. However, since the amplifier 130 generates broadband noise of its own, it is believed that in some cases this broadband noise, which includes noise at spectral locations occupied by the received DWDM channels, may result in a higher OSNR (optical signal-to-noise ratio) penalty.

FIG. 3C illustrates a noise conditioner 320 that adds a second wavelength blocker 330 after the amplifier 130 of FIG. 3B. This embodiment may be advantageous in some cases, as the amplifier 130 need only amplify the noise slices selected by the blocker 120. This results in much higher available power per slice in embodiments having a modest number, e.g. eight, of initial loading lines. A second blocker 330 may substantially reduce or eliminate the broadband ASE from the amplifier 130 at spectral locations other than the desired noise slices. In some embodiments (not explicitly shown) the equivalent per-channel power levels in FIG. 3B are high enough that the blocker 330 is not required. For example, assuming the transmission of 100 G QPSK (quadrature phase-shift keying) optical signals, with a received OSNR requirement of 15 dB or lower, it should be possible to construct the noise source 125, with sufficient power, to ensure that the broadband ASE noise from the amplifier 130 in FIG. 3B results in less than a 0.1 dB OSNR penalty on these DWDM signals.

FIG. 3D illustrates a noise conditioner 340 that adds an attenuator 350, e.g. an eVOA, after the amplifier 130 of FIG. 3B. The attenuator 350 provides the ability to directly control the total noise power added to the received data signals. In some cases it may be preferable that the attenuator 350 be or include a fast eVOA, meaning the response time of the attenuator 350 to a control input is about 100 μs or less. This attenuator response time is decoupled from the intrinsic response time of the amplifier 130. Thus this embodiment is expected to advantageously provide needed gain while also providing sufficient response time without exciting instability in the response of the amplifier 130 when operated in a fast feedback control loop. In one example embodiment, the amplifier 130 is configured to provide about 12 dB of gain for a power output of about 10 dBm. Of course, the attenuator 350 may be used in combination with other embodiments of the noise conditioner with similar effect and benefit.

Note that it expected that the configurations of FIGS. 3B, 3C and 3D are expected to provide benefit when the incoming data streams are combined by a coupler such as the coupler 135 in FIG. 1A, but are not expected to provide significant benefit when the data streams are combined by a WSS such as illustrated in FIG. 1B. Note also that an attenuator (not shown), such as an eVOA, may be located between the amplifier 130 and the blocker 120 in the embodiment of FIG. 3A to provide control of the noise intensity independent of the output power of the noise source 125. This implementation permits fast eVOA-based feedback control even in a WSS-based implementation such as shown in FIG. 1B. Finally, note that in cases for which noise power control implemented by directly controlling the noise source 125 changes the spectral distribution of the noise, it may be preferable to implement noise power control via an eVOA.

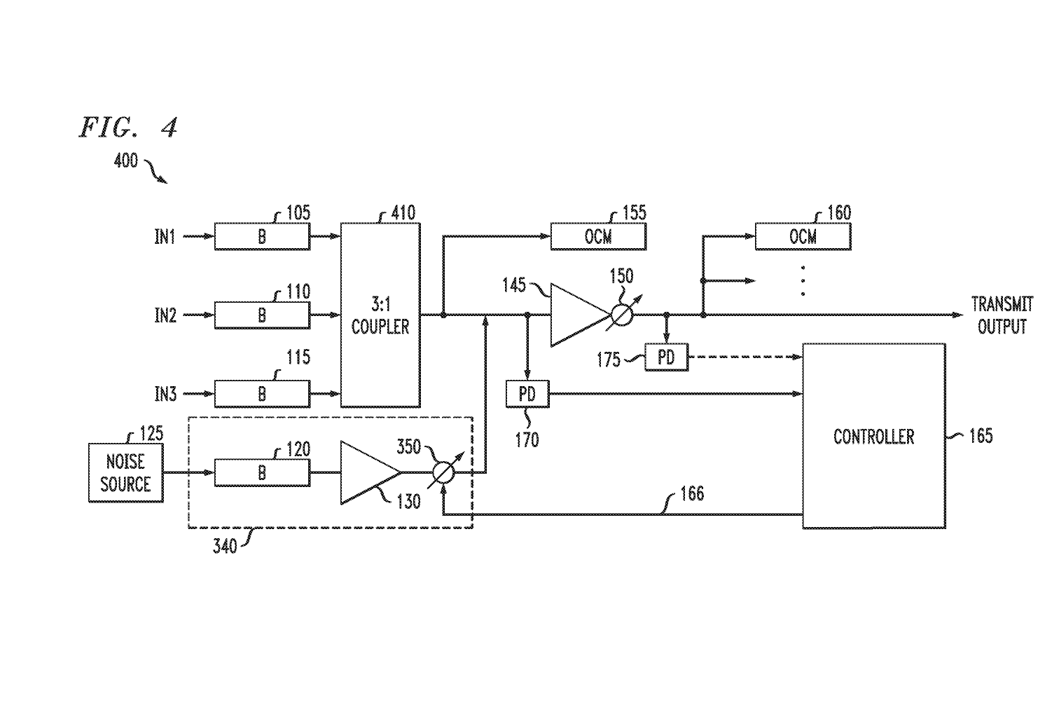

Turning now to FIG. 4, illustrated is an apparatus, e.g. a transmitter 400, according to various additional embodiments. The wavelength blockers 105-115 again respectively receive IN1, IN2 and IN3, while the wavelength blocker 120, amplifier 130, and attenuator 350 are configured as described in FIG. 3D. In this embodiment, the aggregate input from IN1 to IN3 is combined with a 3:1 coupler 410, and the aggregate noise spectrum from the attenuator 350 is added to the output of the coupler 410 before the amplifier 145 via a separate optical coupler (not explicitly shown. Note that the tap output to the OCM 155 precedes the addition of the noise spectrum, and the tap output to the power monitor 170 follows the noise addition. Thus, the OCM 155 taps the coupler 410 output before the noise from the attenuator 350 is added, and the power monitor 170 taps the signal after the noise is added. This implementation permits the OCM 155 to monitor the aggregate DWDM spectrum before noise loading, a solution that is not possible with a 4:1 coupler implementation.

While this implementation may result in higher losses than a WSS-based implementation, e.g. due to additional coupler losses, it is still expected that the per-channel power levels can be −20 dBm or higher. This power level is sufficient to ensure that the OSNR penalty from the broadband ASE noise generated by amplifier 145 is under 0.1 dB on typical 100 Gbs QPSK signals.

The embodiment of FIG. 4 may be advantageous in some circumstances, in that the OCM 160 can be used to detect spectral gaps within the aggregate DWDM spectrum. If there is a sudden loss of one or more channels in the aggregate DWDM spectrum, the OCM 160 configured as in FIGS. 1 and 4, e.g. after noise is added to the aggregate data signal, can still detect the loss, provided the noise conditioner, e.g. the noise conditioner 240, 310, 320 or 340, is not reconfigured to permit noise to be added in these spectral locations. In the configuration of FIG. 4, the blockers 105, 110, and 115 can still be configured, if desired, to permit missing channels to be transmitted should they reappear. In this case, the location of the OCM 160 may be better able to detect the reemergence of these channels even if the noise conditioner has been reconfigured to add noise to these spectral locations. The OCM 160 can be used to provide information to the controller 165 about the total aggregate spectrum, including the noise slices. Also, in addition to the OCM 160, a total power detector (not illustrated) may be added at the same tap point to implement a total power feedback loop via the controller 165. The controller 165 may optionally be configured to also operate based on information from the PD 170 in a feed-forward manner. Preferably, such embodiments include the use of a fast controller 165 and a fast attenuator 350, e.g. a fast eVOA.

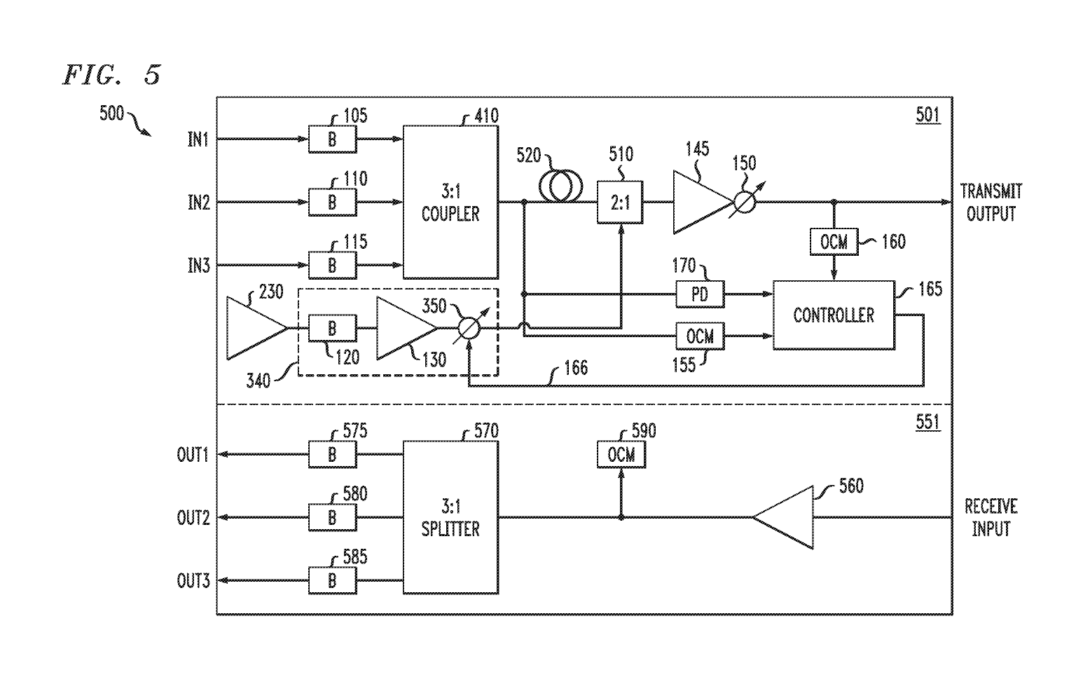

FIG. 5 presents an embodiment of an apparatus, e.g. a transceiver 500, that includes a transmit section 501 and a receive section 551. The transmit section 501 is similar to the configuration described for the transmitter 100, illustrating the EDFA-based ASE noise generating amplifier 230 and the noise conditioner 340 from FIG. 3D, and addition of noise after combining the received data channels as illustrated in FIG. 4. This section is described further below.

Regarding the receive 551 section, included are an input amplifier 560, a splitter 570 and blockers 575, 580 and 585 at respective ones of outputs of the splitter 570. An optional OCM 590 may be used a monitor the output of the input amplifier 560. These components may, but need not, be configured conventionally.

Now further describing the transmit section 501, a coupler 510 is located in the optical path between the coupler 410 and the amplifier 145. The coupler 510 adds noise from the output of the attenuator 350 to the output of the coupler 410. An optical delay line 520 is located between the coupler 410 and the coupler 510. The power monitor 170 and the OCM 155 (explicitly shown connected to the controller 145) sample the coupler 410 output before the delay line 520. The optical delay line 520 may operate to delay the optical signal from the coupler 410 to the coupler 510. By tapping the signal before the delay line 520, the controller 165, in conjunction with the attenuator 350, may quickly respond in a feed-forward fashion to a change of power of the aggregated data signal from the coupler 410. The noise signal into the coupler 510 may be suitably adjusted before the aggregate data signal reaches the coupler 510 via the delay line 520. After the coupler 510, the combined data and noise signal may be processed as previously described by the amplifier 145 and the attenuator 150. The illustrated embodiment also shows the OCM 160 explicitly connected to the controller 145 to provide channel-specific information of the combined signal and noise to the controller 165. The controller 165 may use this additional information to suitably adjust the spectral distribution of noise provided by the attenuator 350, e.g. by controlling the blocker 120.

The described embodiments, e.g. the transmitters 100, 400 and transmit section 501, are expected to provide simple and fast control of transient changes in the data channel spectrum. The fast attenuator 350 is expected to provide faster response time, and well as a fairly consistent noise spectrum as a function of the overall noise power. The effectiveness of the transmitter 100 in achieving rapid response to a dynamic data signal spectrum may require a minimum number of noise channels. Such a minimum is expected to be dependent on the particular configuration of the transmitter 100 and/or the following transmission medium. It is thought that a higher power level of the noise channels relative to the data channels may beneficial to limit the number of needed noise channels. Due to possible transmit issues due to an excessive power differences, it is thought that a maximum difference of about 6 to 10 dB on an integrated per channel or per noise slice basis should be observed. Because the noise power per slice is practically limited, the slow feedback loop may be beneficial to adjust the number of noise slices, as the channel loading changes. Thus, the controller 165 may include a fast transient control loop that adjusts the total noise power, in order to maintain a constant output power after the attenuator eVOA 130, as well as a slower control loop, based on feedback from the OCM 155 and the OCM 160, to reconfigure the blocker 120 to add more slices (and thus reduce the required power per noise slice) when appropriate.

The following examples are provided without limitation to present possible design issues that may be encountered with a transmitter that conforms to the embodiment of the transmitter 100. In a first example, the blocker 120 is implemented using a DLP blocker array, and a 0.1 dB OSNR penalty is targeted due to the transmitter 100. It is assumed for this example that the transmitter 100 transmits a signal modulated using the WDM protocol with up to 96 channels having a 50 GHz channel spacing, with about −20 dBm minimum per channel power into the amplifier 145. Assuming a noise figure of 5.5 dB for the amplifier 145, the equivalent OSNR contribution from this amplifier is 32.5 dB, which results in <0.1 dB on a required OSNR of 15 dB, which is a reasonable working number for 100 G QPSK signals after transmission, depending on the forward error correction coding gain. Additional margin is provided by assuming −17 dBm per channel. In a second example a planned maximum load includes 96 channels into a submarine cable. The actual capacity may be jointly determined by the equipment supplying the DWDM signals, and the optical bandwidth and power capabilities of the submarine amplifiers. Assuming, e.g., that of these 96 potential channels there are 88 DWDM channels present, up to eight noise loading lines may be available. Under typical conditions, the total power per loading line may be the same as the per channel power, in this example −17 dBm. However, since the net bandwidth of a noise slice on the loading line is less than the channel width, the equivalent spectral noise density at the output of the blocker 120 is preferably slightly higher, for example −16 dBm. In the event of a sudden loss of data channels, the fast control loop response of the power control loop may act to increase the power of these eight noise sources, up to a practical limit determined by the specific system implementation. Assuming further that this practical limit is a 10 dBm boost, this would effectively result in enough power to cover 80 channels, or an eight channel net remaining DWDM spectral load (an extreme case). The required equivalent power per 50 GHz channel from the attenuator 350 would then be −6 dBm. Over eight channels, the total output power from the amplifier 130 would be still low, e.g. under 10 dB. In a real-world design, this required output power from this amplifier may be determined by minimum gain requirements in order to obtain a low enough noise figure to minimize this amplifier's broadband ASE contributions. If the amplifier 130 is, optionally, a fixed gain design, then the amplifier may be called on to support this per channel power level across up to 88 channels (for eight actual channels present), with the post-amplifier attenuator 150, e.g. eVOA, attenuating the noise power levels accordingly. In this case, the amplifier 130 may require about 16 dBm of output power capability. Such an amplifier may be considered a low power amplifier, allowing implementation as a low cost single coil/single pump design.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they formally fall within the scope of the claims.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, application specific integrated circuit (ASIC), field programmable gate array (FPGA), read only memory (ROM) for storing software, random access memory (RAM), and non volatile storage. Other hardware, conventional and/or custom, may also be included. Similarly, any Fes shown in the figures are conceptual only. Their function may be carried out through the operation of program logic, through dedicated logic, through the interaction of program control and dedicated logic, in conjunction with the appropriate computer hardware, the particular technique being selectable by the implementer as more specifically understood from the context.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. An apparatus, comprising:
an optical coupler having a plurality of inputs and an output;
an optical noise source configured to produce light having a noise spectrum and being optically coupled to a selected one of the inputs; and
an optical noise conditioner including a wavelength blocker located in an optical path between the optical noise source and the optical coupler, and an optical amplifier located in an optical path between the wavelength blocker and the optical coupler, the optical noise conditioner being configured to receive the light from the optical noise source and to form a noise slice of the noise spectrum.

2. The apparatus of claim 1, wherein the wavelength blocker includes digital mirror device (DMD).

3. The apparatus of claim 1, wherein the optical noise source comprises an erbium-doped fiber amplifier (EDFA) configured to produce self-generated amplified spontaneous emission (ASE) noise.

4. The apparatus of claim 1, further comprising a power control loop configured to modulate the power of the noise slice in response to a total optical power output by the optical coupler.

5. The apparatus of claim 1 further comprising a tap configured to direct a data signal towards another input of the optical coupler, and to direct a monitor signal towards a noise controller configured to adjust a power level of said noise slice in response to a power level of the monitor signal.

6. The apparatus of claim 5, wherein said noise controller is further configured to adjust the power level of the noise slice in response to a power level of an output signal provided by an output of the optical coupler.

7. The apparatus of claim 5, wherein an optical delay line is configured to delay said input signal between said tap and said optical coupler.

8. The apparatus of claim 1, wherein said wavelength blocker is a first wavelength blocker, and further comprising a second wavelength blocker located in an optical path between said optical amplifier and said optical coupler.

9. The apparatus of claim 1, further comprising an optical attenuator located in an optical path between said optical amplifier and said optical coupler.

10. An apparatus, comprising:
an optical delay line configured to receive at an input end an aggregate data signal formed by a combination of a plurality of wavelength-division multiplexed (WDM) optical signals;
an optical coupler configured to receive at a first input said aggregate data signal from an output end of said optical delay line
an optical noise source configured to direct to a second input of said optical coupler noise light including a plurality of noise slices; and
a power monitor configured to receive signal light from a tap located in an optical path before said delay line input and to direct an electrical measure of said signal light to a noise controller configured to modulate a power of said noise light in response to said electrical measure.

11. The apparatus of claim 10, further comprising an optical channel monitor configured to provide spectral information of said signal light to said noise controller, and wherein the noise controller is further configured to modulate a spectrum of said noise light in response to said spectral information.

12. The apparatus of claim 10, wherein said optical channel monitor is a first optical channel monitor, and further comprising a second optical channel monitor configured to provide spectral information of light output by said coupler, wherein said noise controller is further configured to modulate said spectrum of said noise light in response to said spectral information provided by said second optical channel monitor.

13. A method, comprising:
configuring an optical noise source to produce light having a noise spectrum and to direct said light toward a first input of an optical coupler; and
configuring an optical noise conditioner to direct noise light produced by an optical noise source to a second input of said optical coupler, said optical noise conditioner including a wavelength blocker located in an optical path between the optical noise source and the optical coupler, and including an optical amplifier located in an optical path between the wavelength blocker and the optical coupler, the optical noise conditioner being configured to form a noise slice of the noise spectrum.

14. The method of claim 13, wherein the optical noise source comprises an erbium-doped fiber amplifier (EDFA) configured to produce self-generated amplified spontaneous emission (ASE) noise.

15. The method of claim 13, wherein a power control loop is configured to modulate the power of the noise slice in response to a total optical power output by the optical coupler.

16. The method of claim 13, wherein a tap is configured to direct a data signal to another input of the optical coupler, and to direct a monitor signal towards a noise controller configured to adjust a power level of said noise slice in response to a power level of the monitor signal.

17. The method of claim 16, wherein said noise controller is further configured to adjust the power level of the noise slice in response to a power level of an output signal provided by an output of the optical coupler.

18. The method of claim 16, wherein said optical coupler is configured to receive said input signal via an optical delay line configured to delay said input signal between said tap and said optical coupler.

19. The method of claim 13, wherein said wavelength blocker is a first wavelength blocker, and a second wavelength blocker is located in an optical path between said optical amplifier and said optical coupler.

20. The method of claim 13, wherein an optical attenuator is located in an optical path between said optical amplifier and said optical coupler.
